(19) United States
(12) Patent Application Publication
(10) Pub. No.: US 2019/0314868 A1
(43) Pub. Date: Oct. 17, 2019

(54) Method for Restoring Damaged Electronic Devices by Cleaning and Apparatus Therefor

(71) Applicant: Techsave A/S, Randers NØ (DK)

(72) Inventors: Jonas Tedde, Holstebro (DK); Henrik Leth, Holstebro (DK)

(21) Appl. No.: 16/314,908

(22) PCT Filed: Jun. 27, 2017
(86) PCT No.: PCT/DK2017/050213

§ 371 Date: Jan. 3, 2019

(30) Foreign Application Priority Data
Jul. 6, 2016 (DK) PA 2016 70507

(51) Int. Cl. B08B 3/12; F26B 21/08; F26B 21/10; F26B 3/04

(52) U.S. Cl. CPC B08B 3/12; F26B 21/08; F26B 9/06; F26B 3/04; F26B 21/10

(57) ABSTRACT

A method and apparatus for regenerating damaged electronic device by a least one cleaning process and a least one drying process, by submerging one or more electronic devices into an aqueous cleaning liquid in a cleaning chamber (1), and subjecting the aqueous cleaning liquid and the one or more electronic devices to sonication. Drying of the one or more electronic devices is done by periodically heating the cleaning chamber (1) while subjecting the cleaning chamber to reduced pressure and where the cleaning and the drying are carried out in the same cleaning chamber. We hereby achieve a thorough cleaning and restoration of a damaged electronic device.

### FIELD OF THE INVENTION

The present invention relates to a method and a cleaning apparatus to restore damaged electronic devices by a cleaning process. The cleaning process comprises subjection the damaged apparatus and an aqueous cleaning liquid to sonication. Subsequently the damaged electronic is dried.

### BACKGROUND OF THE INVENTION

Today everyone is working with technology and uses computers and tablets, e.g. as an electronic accessory for reading the newspaper or watching television. Unfortunately accidents happen and electronics are sometimes damaged by liquids, e.g. a glass of cola or a cup of coffee tipping over or by being dropped into the toilet. Therefore, there is a big potential for those that are able to salvage the electronics which are damaged by liquids.

When electronic apparatuses are damaged by liquid, this often results in corrosion. The different liquids and the corrosion may result in the electrical circuit to short circuit, and therefore the electronic apparatuses fail.

In the present application electronic devices are to be understood broadly, and encompass in particular portable electronic consumer goods, e.g. laptops, PDA's, tablets, cellphones, hearing aids, clocks, e.g. wrist watches, and the like. In addition, electronic devices may encompass industrially applicable electronic devices comprising a printed circuit board.

Today the electronics are saved by washing the electronics in special washing machines. Most of these washing machines does not dry the electronics in the same chamber and often it is necessary with both a washing machine and a drying machine witch it both impractical with regard to space but also means having to move the washed electronics, from the washing machine to the dryer.

A more convenient washing and drying machine is described in JP 2008-093648 A. This document describes cleaning of electronic equipment, which was damaged by moisture and/or debris. The electronic equipment is arranged to be washed in ultrapure water in an airtight container and cleaned in the ultrapure water using ultrasonic treatment. Thereafter, drying air is provided into the airtight container, possibly at reduced pressure. The drying air is conditioned with regard to temperature and humidity.

There are several problems with this method; it is a costly operation to use ultrapure water in all of the process. The use of only water makes it difficult to remove material that has gotten stuck, such as rust or other materials. The drying is slow, and is difficult to assure the right temperature of the electronics such that the electronic is not overheated or that the electronic is not heated enough so that the left over water is not sufficiently dry.

Another example of an electronic washing machine is described in JP3515668 B2. Describes a method for ultrasonic cleaning of electronics where there are small holes or cavities in the electronic device. The liquid meant for cleaning the electronics may not get into the holes or cavities due to the air in the holes or cavities. By altering the pressure of the surrounding air, the air in the holes is driven out, and it becomes possible for the cleaning liquid to pass into the holes or cavities instead.

The washing machine described above, however only washes and have no drying in the machine, making it impractical as it is necessary to move the electronics to an second machine in order to dry the electronic properly or even worse leave the electronics to dry on its own.

### OBJECT OF THE INVENTION

The objective of the invention is to provide a method and an apparatus that solves the above mentioned problems.

It is further an objective of the invention to provide a method and cleaning apparatus that secures a complete and efficient cleaning and drying of damaged electronic apparatus.

It is also an objective of the invention to provide a method and cleaning apparatus to restore damaged electronic apparatus, where the cleaning and drying of the damaged electronic apparatus is done in the same cleaning apparatus.

### DESCRIPTION OF THE INVENTION

The objective is achieved by a method for regenerating damaged electronic device by at least one cleaning process and at least one drying process, the cleaning process comprises the steps of

a. submerging one or more electronic devices into an aqueous cleaning liquid in a cleaning chamber,

b. subjecting the aqueous cleaning liquid and the one or more electronic devices to sonication

the dying process comprises the step of

c. drying the one or more electronic devices.

Furthermore is the drying of the one or more electronic devices done in a drying cyclus by periodically heating the cleaning chamber and subjecting the cleaning chamber to reduced pressure. Both the cleaning step and the drying step are carried out in the same cleaning chamber.

By using an aqueous cleaning liquid it is often achieved to remove at least a part of the damaging liquids just by using the right aqueous cleaning liquid. The aqueous cleaning liquid furthermore makes it possible to expose the damaged electronic device to sonication.

Sonication is subjecting items to sound waves. Often ultrasound is used with a frequency in the range from approximately 20 kilohertz to several gigahertz. But the method works equally well with lower frequencies as well.

When subjecting the damaged electronics devised and the aqueous cleaning liquid to sonication, the sound waves cause small microscopic air bubbles to arise and subsequently burst in the aqueous cleaning liquid. The mechanical action from the bursting bubbles loosens debris and/or rust formation caused by the aqueous cleaning liquid damage of the electronic device. The mechanical impact from bursting microbubbles also breaks the corrosion layer into small particulate size, thereby improving removal of the corrosion layers inside the electronic device.

Removal of any left-over damaging liquid in the damaged electronic device may also be further assisted because the sonication helps dissolving and/or mixing the damaging liquids in the aqueous cleaning liquid, and again helps remove the damaging liquid.

Therefore by subjecting the aqueous cleaning liquid and the damaged electronic device to sonication is achieved a thorough cleaning of the damaged electronics. Furthermore the cleaning may remove the corrosion and the leftover of aqueous damaging liquids.

The possibility of repeating the cleaning process makes it possibly to customise the method to the amount of liquid damage done to the electronic device. If only a little water has entered the electronic device a single cleaning process step using water may be enough. But, if is the liquid damage is more severe, e.g. if the electronic device, e.g. a cell phone was dropped into a toilet, several cleaning process steps may be necessary in order to remove any potential corrosion and restore all the damage to the electronic components inside the electronic device.

After removing any left ingress liquid, corrosion, dirt and/or debris, using an aqueous cleaning liquid and sonication, it is necessary to remove all of the aqueous cleaning liquid present inside the electronic device to avoid any further corrosion on the electronic components and thus further damage caused by any remaining aqueous cleaning liquid which is not removed efficiently.

Removal of aqueous cleaning liquid remaining in the electronic device is done by periodically heating the damaged electronics and reducing the pressure below atmospheric pressure inside the cleaning chamber, and a thorough drying of the regenerated electronic device is achieved. It is further a more gentle heating as the electronic is left to partly cool down between the heating while evaporating the aqueous cleaning liquid.

Thus, the combined cleaning and drying method according to the present invention results in that the electronic device in most cases becomes fully functional after completion of the regeneration procedure according to the present invention. Thus, in addition to saving any data stored in the electronic device, the electronic device in most cases becomes fully functional.

It is to be understood for the rest of this application that a reduced pressure is reducing the pressure in the cleaning chamber below atmospheric pressure and/or below the pressure currently present in the cleaning chamber. This may also be called applying a vacuum. Throughout the application the pressure is provided in absolute pressure.

In addition, the application of a vacuum during the drying cycles, allows for applying a vacuum in the cleaning chamber prior to applying the cleaning liquid to the cleaning chamber. Thereby, the vacuum applied in the cleaning chamber can be used for transferring the cleaning liquid(s) into the cleaning chamber. This is significantly faster than by transferring the cleaning liquids by means of traditional pumping means. In addition the application of vacuum ensures removal of air bubbles trapped inside the electronic devices as discussed below.

When subjecting the cleaning chamber to pressure reduction while drying, the boiling point of the aqueous cleaning liquid is lowered. Thereby is the air present in the cleaning chamber is further below the saturation point whereby the evaporation rate is faster at a reduced pressure compared to the same temperature and at atmospheric pressure. This results in an efficient drying at lower temperatures when compared to temperatures necessary without applying a pressure reduction in the cleaning chamber.

Reducing the temperature in the drying step provides a gentle drying of the electronic device. The gentle drying step or drying steps reduces the risk of damaging the electronic devices by the heat applied during the drying step or steps.

This further leads to energy savings as an efficient drying is provided at reduced temperatures. Heating is only periodically instead of heating all the time.

Both the cleaning process and the drying process are carried out in the same cleaning chamber. Hereby is achieved less handling of the damaged electronic device. Furthermore, only one cleaning apparatus is provided to carry out the cleaning and the drying. This saves space and reduces handling time between cleaning and drying cycles. In addition, less materials and/or parts are provided when only one apparatus is provided. This further leads to overall reduced costs for restoring the damaged electronic devices.

The periodically heating of the cleaning chamber is preferably done in at least one, preferably two, three or more steps.

Hereby is achieved time to let the damaged electronics partly cool down, and leaves time for the aqueous cleaning liquid to evaporate. This also saves energy as the heating is only on temporary, instead of the whole time.

Preferably the reduced pressure is changed stepwise during drying of the one or more electronic devices.

By having a stepwise change of the reduced pressure, the pressure is adjusted to the amount of water that is to be evaporated to ensure proper drying of the electronic device. As the first step of drying by heating under reduced pressure has been carried out, a substantial part of the aqueous cleaning liquid is evaporated, leaving less water to be evaporated in the subsequent drying cycle or cycles.

Preferably the frequency of the sonication may be varied.

The exact frequency of the sonication may be adaptable to the cleaning that is required. In general, the higher the frequency of the sonication, the better cleaning. However, the problem with higher frequencies is that the device may be damaged by the high frequency. For example the colour of plastic cover may fade and plastic components may eventually start cracking if the frequency gets too high.

An example of a cleaning process is removal of a chewing gum. At 30 khz the chewing gum will be loosened from the electronic device in one piece. At 80 khz, the chewing gum is loosened and will be crushed into particulates, which may small enough enter to the interior of the electronic device during the cleaning cycle and thus cause further damage to the electronic components in the electronic device. So though the electronic device will get clean at 80 khz, at better choice may be 30 khz, and then get the chewing gum of in one piece.

Experiments have shown that corrosion arising from ingress of liquids containing water in damaged electronic devices is efficiently removed at ultrasonic frequencies of approximately 60-100 khz.

As seen from the example above is the best choice of frequency during sonication depends on the damage which is made to the electronic device, the time it takes to clean the damaged device and the how gentle the cleaning is going to be.

Preferably the frequency of the sonication is adjustable and may be adjusted to the cleaning process and/or varied during at least one cleaning substep.

The amplitude may also be selected and/or varied to avoid standing waves in the cleaning chamber.

Both the frequency and/or the amplitude may be varied continuously around the selected frequency and/or amplitude during one or more of the cleaning cycles. Varying the frequency and/or amplitude is done in order to avoid standing waves in both the cleaning chamber as well as in the damaged electronic devices. Inside the electronic devices the different components are of various size. The different components in the electronic device therefore may have standing waves at different frequencies. As there are many parts in an electronic device there are many frequencies that may result in standing waves. Standing waves may therefore be avoided by changing the frequency and/or the amplitude continuously.

For choosing the ideal frequency and/or amplitude, the method for regenerating damaged electronic device may include an intelligent frequency and/or amplitude selector. The choice of frequency may depend on that the specific electronic device that is damaged, and on the damage that have accrued to the electronic device. The intelligent frequency selector may then choose the ideal frequency for the cleaning steps according the damaged electronic device and the damage that have happened.

It is preferred that a number of preprogrammed cleaning scenarios are provided in the apparatus to allow for selection of an appropriate programme, which is adapted to the specific type of electronic devices that are to be treated. Thus it may be possible to select programmes which are adapted for restoring laptops, tablets, cellphones and/or possibly other consumer electronic devices. The method and apparatus are likewise able to perform restoration of industrially applicable electronic devices comprising printed circuit boards which have been damaged, e.g. by ingress of water.

The intelligent frequency selector may recognize the specific electronic device, either by weight or by image recognition or by an entry from a user.

The intelligent frequency selector may be self-learning, saving the result from earlier cleanings to improve the future recommendations for frequency selections.

Preferably, it is possible for the operator and/or administrator to choose the frequency independent of the intelligent frequency selector's recommendation.

Preferably, the periodical heating of the cleaning chamber during the one or more drying cycles provides a chamber temperature of 20-100° C., such as 35-80° C. or preferably 45-70° C.

By changing the temperature in each of the heating cycles is it possible to adapt to the amount of aqueous cleaning liquid that needs to be evaporated in the drying cycle. For example in the first heating step, there is a lot of aqueous cleaning liquid, and even at low temperatures a lot of the aqueous cleaning liquid would evaporate because the pressure is reduced to below atmospheric pressure.

At subsequent heating steps, a higher temperature may be needed to ensure evaporation of the aqueous cleaning liquid. By changing the temperature a gentler drying is achieved.

It is noted that elevated temperatures over a longer time interval is not good for electronic devices. Thus by increasing the temperature in a relatively short interval while also reducing the pressure, the maximum temperature to which the electronic device is exposed, is reduced as well is the time interval to which the electronic device is exposed to elevated temperatures. This reduces the risk of damaging the electronic device by heating.

During drying of the electronics the absolute pressure in the cleaning chamber is preferably 0.01 bar-0.9 bar, such as 0.1 bar-0.8 bar, such as 0.2 bar-0.6 bar, such as 0.90 bar-0.99 bar, such as 0.95 bar-0.99 bar, such as 0.95 bar-0.98 bar.

Changing the pressure may optimize the energy consumption in relation to the amount of water that is to be evaporated, ensuring the amount of water the air has the ability to contain to allow for efficient drying of the electronic devices. This allows for adjustment of the pressure in relation to the temperature used in the relevant drying cycle and provides possibility of adjusting to the amount of water that has to be evaporated at the different steps of the heating cycles.

The lower the pressure, the faster is the drying. But reducing the pressure close to vacuum also results in increasing of energy consumption in the pumping means provided to reduce the pressure in the cleaning chamber. If a fast drying is wanted, a pressure going down to 0.01 bar or lower is possible, but the costs in energy consumption is significant. Is the time not critical, it is more reasonable to choose a drying pressure of about 0.2 bar or higher, thereby having a lower energy consumption in the pumping means.

Preferably, the method comprises a drying cyclus in which the drying cyclus comprises the steps of

a: heating air entering into the cleaning chamber to a temperature of at least 60° C. at a first reduced pressure,

b: maintaining a chamber temperature of 35-80° C. and a second reduced pressure,

c: reducing the pressure to a third reduced pressure level.

This particular drying method according to the present invention results in that the electronic device in almost every cases becomes fully functional after completion of the regeneration procedure according to the present invention, because it is possible to ensure that substantially all residual water is removed from the interior of the electronic device. This reduces the risk for short circuiting, corrosion or similar effects that may be results of water present in the electronic device are eliminated. Thus, in addition to saving any data stored in the electronic device, the electronic device in most cases becomes fully functional.

In step a, a heating boost is applied to the air in the chamber to ensure fast and effective evaporation of water residues present inside the electronic device and inside the chamber. The air that enters and/or circulates into the chamber is heated to at least 60° C. in order to obtain a chamber temperature of 35-80° C., or 45-70° C. or preferably 45-55° C. to avoid thermal damage on the components in the electronic device. The pressure is maintained at a slightly reduced level, preferably at 0.5-0.9 bar or 0.55-0.75 bar.

In step b, the pressure is maintained or allowed to increase slightly because of evaporation of water. The pressure in the chamber is thus preferably at 0.5-0.9 bar or 0.55-0.75 bar.

The evaporating water causes a temperature drop in the chamber. In order to counteract too large a temperature drop it may be necessary to provide additional heating in step b. The chamber temperature is thus preferably maintained at 35-80° C., or 45-70° C. or preferably 45-55° C. to ensure continued evaporation of residual water. Heating may thus in some situations be necessary in relatively short intervals of between e.g. 10-120 seconds.

In step c, the pressure is reduced even further to drive evaporation of any remaining residual water inside the electronic device and thus ensure efficient drying of the electronic device. The pressure is preferably reduced to 0.01-0.5 bar in step c, while leaving out heating in step c. It will be the vacuum that ensures evaporation of residual water in step c.

As mentioned above, it is essential that all water is removed from the internal parts of the electronic device in order to ensure that the electronic device is fully functional after completion of the regeneration process. Therefore, the steps b-c in the drying cyclus may be repeated at least one, two, three, four, five, six, seven, eight, nine, ten or more times depending on the amount of water that needs to be removed from the electronic devices during the drying step.

If necessary, in the final repetition of steps b-c, the final substep c may be prolonged in duration in relation to the preceding cycles, to ensure that the internal part of the electronic device is dry and substantially all residual water is drawn out of the electronic device before finalizing the regeneration procedure.

The duration of steps a-c may be based on a preset time duration to ensure evaporation of the water present in the electronic device after the washing and/or rinsing steps. In steps a and b the chamber temperature is maintained at the desired level, as described further below, or in particular to obtain a chamber temperature of 45-55° C. This may be obtained by step a having a duration of 100-720 seconds, or 180-540 seconds or 240-480 seconds.

Alternatively, the duration of the sub steps a-c may be controlled by means of a humidity sensor that detects humidity in the air present in the chamber.

The cleaning liquid is aqueous, i.e. it is based on water as the main component. Preferably the aqueous cleaning liquid comprises water, such as tap water, distilled water, and/or demineralised water. Optionally the aqueous cleaning liquid further comprises one or more detergents, such as one or more alkaline detergents and/or acidic detergents. The detergents may alternatively have amphoteric properties and/or be a mixture of the above mentioned.

The composition of the aqueous cleaning liquid depends on the damage that has been done to the electronic device. Smaller damages to an electronic device may be restored by cleaning using an aqueous cleaning liquid comprising only water. Alternatively, extensive corrosion and rust inside the electronic device may be removed with an aqueous cleaning solution comprising one or more alkaline, acidic and/or amphoteric cleaning agents.

Heavily damaged electronic device(s) may need cleaning in more than one cleaning substeps. An aqueous cleaning liquid comprising an alkaline or an acid detergent may be applied in a first cleaning step. An optional second cleaning step may be provided with an aqueous cleaning liquid consisting of water. The second cleaning substep may thus be a rinse substep without subjecting the aqueous cleaning liquid and the electronic device to sonication. There may be an optional third cleaning substep with an acidic or alkaline detergent. Preferably, if an alkaline detergent was used in the first cleaning substep, an acidic detergent is used in the third cleaning substep and vice versa. Optionally there may be a fourth cleaning sub step using water. The fourth cleaning substep may be a rinse substep without subjecting the water and the electronic device(s) to sonication.

Thereby at the method may be adapted to the amount of damage that has occurred to the electronic device or devices. This is achieved by adapting the cleaning process to comprise only the cleaning steps necessary to the specific damage made to the electronic devices.

In an alternative embodiment is it possible to have the aqueous cleaning liquid, in one or more of the cleaning substeps, replaced by for example a plasma liquid, reactive air, organic solvents, ammonia or other liquids or gasses suitable for cleaning damaged electronic devices.

To most electronic devices regular tap water is sufficient to provide efficient cleaning of the electronic devices. When treating special equipment demineralised water may be required. Demineralised water may be used for all electronic device, however imposes higher costs than using tap water and it is therefore an advantage to use regular tap water whenever possible. The present invention thus allows that the use of ultrapure water can be avoided. Production of ultra pure water is very costly and use of does not provide any significantly improval in cleaning efficiency in the method and system according to the present invention. However, it is possible to use ultra pure water in the method and system according to the present invention if a customer wishes so.

One or more water purifying steps may be applied to the spent aqueous cleaning liquids whereby the water used in the cleaning steps is purified. In addition or alternatively, it is possible to collect the aqueous cleaning solution or water used in a rinsing cycle and reuse the water in one or more of the first cleaning substeps in a subsequent cleaning cycle. Thereby, the water consumption is significantly reduced.

Purification of cleaning liquids and/or rinsing liquid, in particular water, to allow for reuse is done by regular means such as membrane and/or osmosis water filtering processes, water purification using bacteria, precipitation or filtration of the waste aqueous cleaning liquid, distillation, ion exchange, adsorption and/or absorption of impurities, e.g. by active carbon filter, electrolysis, such as to eliminate metals and/or minerals, e.g. copper lead etc., and/or combinations thereof.

The object of the invention may further be achieved by a damaged electronic restoration apparatus for restoring electronic devices damaged by e.g. ingress of liquids, by means of a cleaning process. The apparatus may comprise
a pressure tight and/or airtight cleaning chamber,
at least one liquid inlet means arranged for at least partly fill the cleaning chamber with an aqueous cleaning liquid thereby submerging the damaged electronic in the aqueous cleaning liquid
at least one liquid outlet means arranged for emptying the cleaning chamber for aqueous cleaning liquid
one or more sonic probes for subjecting the aqueous cleaning liquid and the electronic device to sonication, and
at least one pumping means for subjecting the cleaning chamber to a reduced pressure, and wherein the cleaning chamber additionally comprises
one or more air entering means for entering air into the chamber
one or more temperature regulating means
   whereby the cleaning chamber is also configured as a drying chamber, to dry the regenerated electronic devices in one or more drying steps under reduced pressure.

By having at a pressure tight and/or airtight cleaning chamber, it is possible to lower the pressure in the chamber below atmospheric pressure. Thereby is a faster drying achieved because the aqueous cleaning liquid, e.g. water, evaporates at higher rates at a certain temperature when the pressure is below atmospheric pressure compared to the evaporation rate at atmospheric pressure.

The at least one liquid inlet means makes it possible to allow the aqueous cleaning liquid to enter into the cleaning chamber. It is possible to have a single liquid inlet through which all liquids are passed into the chamber. It is however also possible to have several inlet means, for example one inlet means for each of the different liquids that are used in the cleaning process.

The at least one liquid outlet means is arranged to empty the cleaning chamber for aqueous cleaning liquids. There may be only one liquid outlet means, that empties all liquids out of the chamber, or there may be several liquid outlet means, depending on what kind of liquid and what to do with it after the relevant cleaning step. For example, there may be one liquid outlet connected to the sewer, one liquid outlet to allow for collection and reuse of the aqueous cleaning liquid(s), and/or one or more outlets for reuse of aqueous cleaning liquid with the respective detergents. Other outlet means are also possible.

The one or more sonic probes makes it possible to subject the cleaning chamber, more specifically the aqueous cleaning liquid and the damaged electronic devices, to sonication and thereby to clean the damaged electronic device. By subjecting the damaged electronic device to sonication is achieved that the damaging liquid and/or caroused material is broken into minor pieces and/or dissolved into the aqueous cleaning liquid.

Preferably the sonic probes are arranged to subject the cleaning chamber to sonication from at least two sides, preferably from two opposite sides.

The sonication from the at least two sides may be symmetric, asymmetric. In addition, or alternatively the sonication may be applied in synchronous or asynchronous waves to further improve cleaning of rust, dirt etc. when during restoration of the damaged electronic devices.

There may be sonic probes on more than two sides, such as three, four, five, or six sides.

The at least one pumping means is arranged for subjecting the cleaning chamber to a reduced pressure. Preferably the at least one pumping means is a vacuum pump. The at least one pumping means allows for adding the aqueous cleaning liquids(s) of the cleaning chamber by suction during the one or more cleaning substeps. In addition the pumping means allow for reducing the pressure to below atmospheric pressure during the one or more drying sub steps.

The air entering means are arranges for allowing atmospheric air to enter into the chamber. Air is entered both when the pressure is to be released. Further, air may be entered into the cleaning chamber during drying in order to remove the evaporated moist from the cleaning chamber.

The temperature regulating means are arranged for controlling the temperature in the cleaning chamber, especially during the drying steps of the restored electronic device. The temperature regulating means may comprise a heating element inside the cleaning chamber that heats the entire chamber. Alternatively, the heating element may be applied in connection to the bottom or a sidewall of the cleaning chamber.

Alternatively, may the temperature regulating means provided to allow hot air entered through the air entering means, heating the chamber with hot air. The heating means may comprise a thermal heating element and/or an air to air heat exchanger, which exchanges heat with air leaving the cleaning chamber.

By having the cleaning chamber configured to act also as a drying chamber, there is achieved less handling of the damaged/regenerated electronic devices. In addition, the application of cleaning chamber and drying chamber in one and the same chamber allows for a fully automatized process.

Furthermore is less space needed to ensure proper regeneration of the damaged electronic devices as there is only one device with one chamber used for cleaning as well as drying instead of two separate devices, one for cleaning and one for drying.

This further results in less handling of the damaged/regenerated electronic devices. Thus, the owner or user of the damaged electronic device need to use less time on waiting for restoration of the damaged electronic device. This further result in reduced costs for restoration of the damaged electronic device.

Drying the restored electronic device under reduced pressure achieves a faster and more thorough drying.

Preferably filling of liquid into cleaning chamber is done by the at least one pumping means applies a reduced pressure to the cleaning chamber and thereby sucks the aqueous cleaning liquid into the cleaning chamber through the at least on liquid inlet means.

Thereby less air bubbles remains in the damaged electronic device as air is sucked out of the cleaning chamber and also from the interior of the damaged electronic device. This result in that the cleaning is more comprehensive. When an electronic device is submerged into a liquid, there may be air bubbles trapped inside the electronic device. When an air bubble is trapped, the following cleaning using sonication of the aqueous cleaning liquid is ineffective where the air bubble is trapped inside the damaged electronic device.

Therefore there is a risk that the damaged electronic device is not cleaned everywhere if air bubbles are trapped inside the electronic device during the cleaning steps. The risk of this happening is elegantly solved by sucking the aqueous cleaning liquid into the cleaning chamber at reduced pressure.

Furthermore is the pumping means required in the drying process, and it is therefore possible to save a pump in the damaged electronic restoration apparatus, making the damaged electronic restoration apparatus simpler and easier to maintain, and thereby having cheaper cost.

Preferably the cleaning liquid inlet means is also functioning as spent liquid outlet means.

Hereby is achieved a simpler layout of the regeneration, i.e. cleaning and drying, apparatus regenerating the damaged electronic devices. When providing less inlet and outlet means an apparatus is thereby less likely to fail. In addition, the regeneration apparatus is less costly to produce.

Alternatively is it possible to have only two inlet/outlet means. Thereby the liquid inlet may function as liquid outlet means and air inlet and a second inlet/outlet means may act as air inlet or outlet means.

Preferably the restoration apparatus comprises at least one liquid tank for storing at least a part of the used aqueous cleaning liquid.

Hereby is achieved the possibility to recycle the used aqueous cleaning liquids for later use, thereby saving resources and reducing the running costs for the damaged electronic restoration apparatus.

Preferably the restoration apparatus comprises means for reuse of aqueous cleaning liquid or liquids in the one or more cleaning steps.

Hereby is achieved reuse of aqueous cleaning liquids and thereby using less resources and reduces overall costs for restoration of the damaged electronic devices.

Purification of cleaning liquids and/or rinsing liquid, in particular water, to allow for reuse is as discussed above in relation to the method.

Preferably the cleaning chamber further comprises at least one condensation plate.

Hereby is achieved an effective way to remove moist form the chamber during drying of damaged/restored electronic devices. The condensation plate may operate by cycling a cooling media, e.g. cold water or another cooling agent through the condensation plate to provide a cool surface on which humidity in the air may condensate inside the chamber, e.g. during or subsequent to the one or more drying steps.

Alternatively, the air humidity may be removed from the chamber by circulation of hot and/or dry air through the chamber. This result in removal of humidified air that is ventilated out of the chamber such that the humidity in the chamber is lowered resulting in an efficient drying of the damaged/restored electronic devices, and thereby saves time in the drying process.

It is possible to remove unwanted substances from the air leaving the apparatus through the vacuum pumping means by conventional methods such as e.g. filtering the air through an activated carbon filter and/or bubbling the air through water.

As discussed above the inlet and/or outlet of aqueous cleaning liquids, rinse liquids etc. may be arranged in multiple ways.

When cleaning the damaged electronic devices there may be applied more than one aqueous cleaning liquid. In one embodiment there is only one liquid inlet and there may be multiple valves on the non-chamber side of the liquid inlet. The number of valves may be arranged by a number of single valves, or alternatively one, two or more three-way valves or four way valves or valves with more inlets and a single outlet may be applied on the inlet to the cleaning chamber. Alternatively one or more a valve manifolds are used on the inlet to allow for the different aqueous cleaning liquids, rinsing liquids to enter and/or leave the cleaning chamber. Alternatively is it possible to apply a mixture of the mentioned valve arrangements.

The liquid outlet may be arranged to have more than one vent, there may be a multiple of liquid tanks to receive the aqueous cleaning liquids and allow for reuse the aqueous cleaning liquids. A final drain to the sewer may be applied and used for draining aqueous cleaning liquids when the aqueous cleaning liquids are not usable anymore.

Preferably there is only one liquid outlet and there may be a multiple of valves on the non-chamber side of the liquid outlet as described in relation to the liquid inlet.

Preferably the valves used to the liquid inlet and/or the liquid outlet are preferably arranged in slanted manner.

Preferably, the valves used throughout the system are pneumatically or hydraulically driven valves.

In a particularly preferred version, the liquid inlet also acts the liquid outlet and valve means as mentioned above ensure distribution of liquid to and/or from the cleaning chamber.

When entering liquid into the cleaning chamber, the aqueous cleaning liquid may be pumped into the cleaning chamber. Alternatively, the aqueous cleaning liquid is sucked into the cleaning chamber by having a reduced pressure in the cleaning chamber. alternatively, the liquid is partly sucked into the cleaning chamber by the reduced pressure, and partly pumped into the cleaning chamber by means of one more pumps.

When emptying the chamber of aqueous cleaning or rinsing liquid it is possible to pump the liquid out of the cleaning chamber using one or more pumps. This is an easy and simple design.

Alternatively emptying liquids from the cleaning chamber may be done by gravity instead of pumping. The advantages are fewer pumps and therefore less maintenance. Furthermore, there is less liquid trapped in the construction, and therefore at better reuse of liquid.

If the vacuum pump has a breakdown the safety measures include an air tank that may relieve the pressure in the cleaning chamber. Alternative there may be a compressor arranged to relieve the pressure in the cleaning chamber.

### DESCRIPTION OF THE DRAWING

FIG. 1 shows simple view of a damaged electronic restoration apparatus FIG. 2 shows an implementation of sonic probes mounted on the sidewall of the cleaning chamber

FIG. 3 shows a complete view of an embodiment of the restoration apparatus.

FIG. 4 shows one embodiment of the method to regenerate damaged electronic devices.

FIG. 5a-5g shows the inlet and outlet of liquid from the cleaning chamber with only gravity and a vacuum-pump.

### DETAILED DESCRIPTION OF THE INVENTION

The following are examples of how the method and apparatus for restoring damaged electronic devices are accomplished.

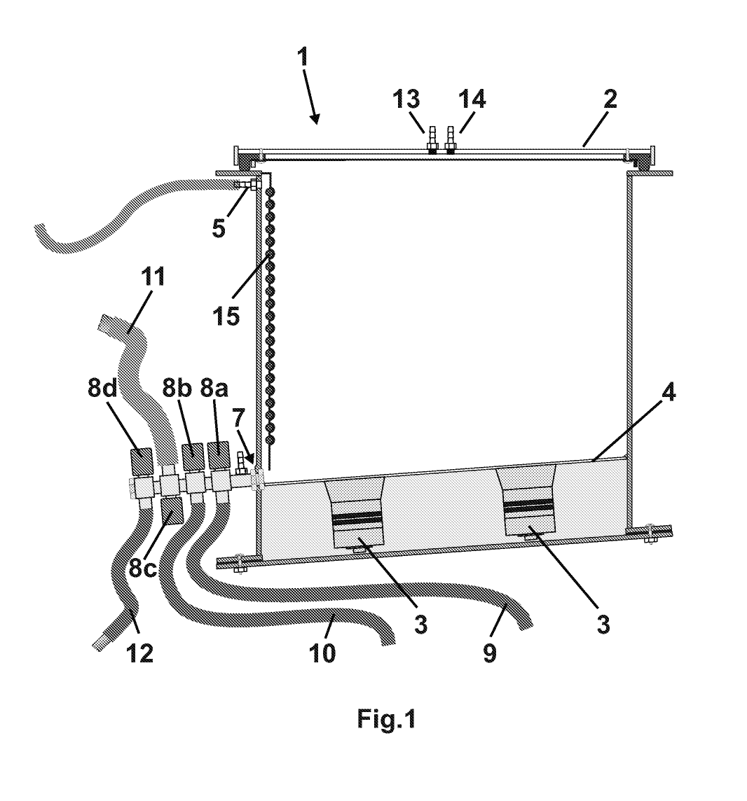

FIG. 1 shows an example of a cleaning chamber for a damaged electronic restoration apparatus.

The restoration apparatus comprises a cleaning chamber 1 having a lid 2. The 2 lid closes the cleaning chamber 1 in an air and/or pressure tight manner. In the lower end of the chamber are placed two sonic probes 3 placed towards an inner plate 4. In FIG. 1 is the bottom of the cleaning chamber, but the sonic probes might as well be placed towards a side wall. The sonic probes 3 are connected to the inner plate 4 such that the inner plate transfers the vibration from the sonic probes to the aqueous cleaning liquid in the cleaning chamber.

In the upper part of the cleaning chamber 1 is an outlet 5 for a vacuum pump 6 (not shown in FIG. 1), whereby the vacuum pump 6 may reduce the pressure inside the cleaning chamber 1 to a level below the atmospheric pressure. In the lower end of the cleaning chamber 1 is an inlet/outlet 7 for aqueous cleaning liquid followed by a number of valves 8a, 8b, 8c, 8d. The valves have four connections; two valves 8a, 8b for aqueous cleaning liquids 9, 10, one valve 8c fore drying air 11 and one valve 8d for emptying the aqueous cleaning liquid out of the cleaning chamber 1. In the top of the cleaning chamber 1 is optionally another inlet for air 13 and an extra inlet 14 for cleaning liquid.

When drying the damaged electronic devices it is possible to remove the moist from the chamber by using a condensation plate 15.

The base of the cleaning chamber has a slight slant towards the inlet/outlet 7, thereby making it easier to empty the cleaning chamber 1 of liquids.

When cleaning a damaged electronic device, the damaged electronic device is placed inside the cleaning chamber 1 on the inner plate 4, e.g. by placing the electronic devices in a basket or similar holder. The cleaning chamber 1 is then completely or at least partly filled with an aqueous cleaning liquid.

The cleaning chamber 1 is preferably filled up with aqueous cleaning liquid by having the vacuum pump 6 applying a vacuum in the cleaning chamber 1. By opening the valve 8a, 8b to one of the connections to the aqueous cleaning liquid inlets 9, 10, the aqueous cleaning liquid will be sucked into the chamber through the inlet/outlet 7 in the bottom of the cleaning chamber 1 by the reduced pressure in the cleaning chamber 1.

The vacuum applied may be a maximum applicable vacuum which is applied prior to allowing the cleaning liquid to be transferred to the cleaning chamber. The maximum level of vacuum may e.g. be a pressure of 0.01 to 0.2 bar (absolute pressure). This allows for very fast transfer of liquid to the cleaning chamber and further reduces the processing time of the entire restoration process.

Alternatively, the vacuum pump may gradually apply a vacuum while transferring the cleaning liquid to the cleaning chamber. A pressure of e.g. 0.3-0.5 bar may then be applied to the cleaning chamber while the liquid is transferred to the cleaning chamber.

Alternatively, the cleaning chamber 1 may be filled with the aqueous cleaning liquid by pumping the aqueous cleaning liquid into the cleaning chamber by a pump (not shown in FIG. 1).

Another alternative for filling the cleaning chamber 1 with aqueous cleaning liquid is through the inlet 14 in the top of the cleaning chamber 1.

When the cleaning chamber 1 is at least partly to completely filled with aqueous cleaning liquid the sonic probes 3 subject the cleaning chamber 1 and the damaged electronic device and the aqueous cleaning liquid to sonication, thereby cleaning the damaged electronic device.

After sonication the cleaning chamber 1 is emptied of the now used aqueous cleaning liquid. Emptying of the cleaning chamber 1 occurs through the inlet/outlet 7 in the lower part of the cleaning chamber 1. By activating the valve 8d to the connection for emptying aqueous cleaning liquid, the now used aqueous cleaning liquid, either runs out of the chamber pulled out by gravity or is pumped out by a pump (not shown in FIG. 1).

The cleaning substeps may be repeated one or multiple times, possibly also alternating with a rinsing with for example water. Each time the cleaning chamber is filled the partly or full of aqueous cleaning liquid, and then the e aqueous cleaning liquid and the damaged electronic device is subjected to sonication. After sonication, the cleaning chamber 1 is emptied of aqueous cleaning liquid.

After a thorough cleaning the damaged electronic device is now restored, but needs to be dried to avoid any remaining liquid remaining inside the electronic device to cause new corrosion of the metallic parts or components in the electronic device

The drying step is carried out under reduced pressure by reducing the pressure to below atmospheric pressure. The vacuum pump 6 (not shown in FIG. 1) reduces the pressure by pumping out air through the outlet 5 for a vacuum pump 6.

The reduced pressure makes the left over liquid in the damaged electronic device vaporise raising the humidity of the air in the cleaning chamber.

The humidity of the air in the cleaning chamber 1 may be reduced by circulating air through the cleaning chamber 1, while still keeping the cleaning chamber at reduced pressure. The air enters through the air inlet 13 at the top of the cleaning chamber 1 and out through the inlet/outlet 7 to the drying air outlet 11 at the bottom of the cleaning chamber 1.

Alternatively the air humidity may be removed by providing a condensation plate 15 in the cleaning chamber 1.

The reduced pressure is periodically changed during periods with heating the cleaning chamber 1 as discussed above. This improves drying of the restored/damaged electronic devices.

FIG. 2 shows an alternative positioning of the sonic probes 3. The sonic probes 3 are still connected to an inner plate 4. The inner plate 4 is in a vertical direction in one of the sides of the cleaning chamber 1. There may be more inner plates with more sonic probes, e.g. by applying sonic probes at several inner walls. Preferably, there are sonic probes on two opposite sides of the cleaning chamber, which enables subjecting the cleaning chamber and the aqueous cleaning liquid for sonication from two opposite sides.

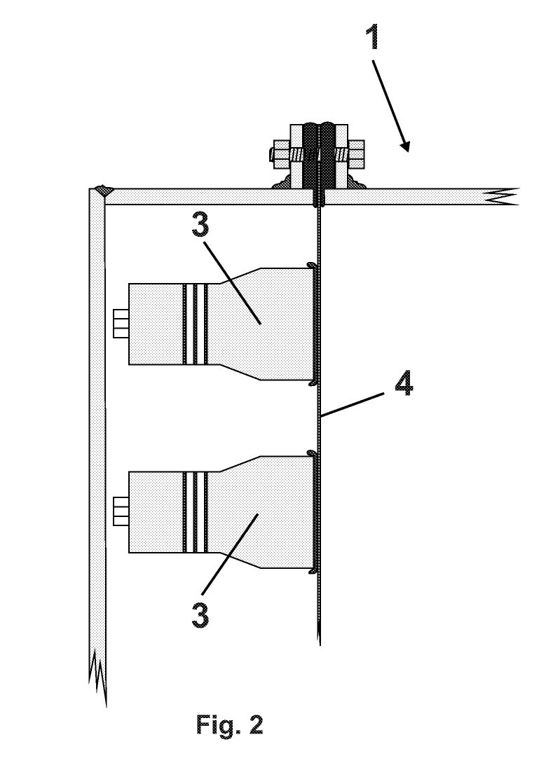

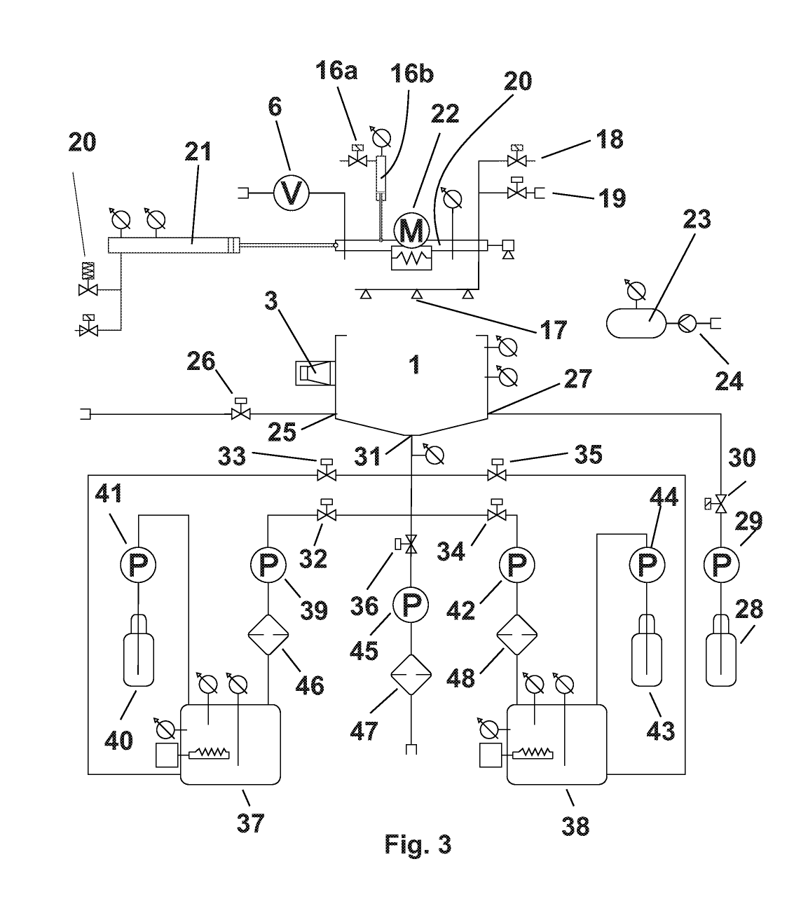

FIG. 3 is an overview of the complete a damaged electronic restoration apparatus for restoring electronic devices damaged by e.g. ingress of liquids.

The lid 2 is closed by activating a magnetic valve 16a to an air chamber 16b.

In connection to the lid 2 there is a sprinkler 17 functioning as both an inlet for aqueous cleaning liquid, such as water and/or an inlet for air. The liquid inlet to the sprinkler is controlled by a first liquid inlet valve 18. Similarly is the air inlet controlled by an air valve 19. The air inlet is mainly for reliving the pressure inside the cleaning chamber after a cycle running under reduced pressure.

In connection to the lid 2 is a pressure relief valve 20 as a safety measurement. Furthermore, another air cylinder 21 is provided to allow movement of the lid 2.

Mounted on the top of the lid 2 is a heating element 22 arranged to heat the cleaning chamber 1 when drying the damaged now restored electronic device.

There is an air tank 23 with a check valve 24, which can provide pneumatic pressure to the valve actuators in case the supply of pressurized air to the pneumatically driven valves is interrupted. This can be detected by means of a pressure sensor applied to the pneumatic system. This safety provision also allow for the programme to run to the end and to allow for opening of the lid 2 when the cleaning and drying cycles are finalized, even if pneumatic pressure is interrupted.

The sonic probes 3 are placed in connection to a side wall of the cleaning chamber 1.

The cleaning chamber 1 has several three liquid inlets, preferably at least two or at least three liquid inlets arranged to allow liquid into the lower part of the cleaning chamber 1. One of the inlets may also functions as a liquid outlet.

The first liquid inlet 25 is a water inlet, either to allow addition of tap water or demineralised water into the cleaning chamber 1. The water inlet is controlled by a water inlet valve 26.

The second inlet 27 is concentrated aqueous cleaning liquid. The concentrated aqueous cleaning liquid is stored in a container 28 and pumped into the cleaning chamber by a first cleaning liquid pump 29. The second inlet 27 is controlled by a first cleaning liquid control valve 30.

The last inlet 31 is also arranged to function as an outlet for the aqueous cleaning liquid(s). Filling and/or emptying the cleaning chamber through the inlet/outlet is controlled by a number of valves.

When emptying the cleaning chamber for aqueous cleaning liquid it is emptied through the inlet/outlet 31. The aqueous cleaning liquid may be recovered and stored in one of at least two cleaning liquids tanks 37, 38.

When emptying aqueous cleaning liquid from the cleaning chamber and into the first liquid tank 37, the outlet 31 is activated by a first liquid outlet valve 32 and then aqueous cleaning liquid is pumped out of the cleaning chamber 1 by a first liquid outlet pump 39 into the liquid tank 37.

As the aqueous cleaning liquid has been used, the cleaning abilities may have deteriorated. It is there for possible to add extra concentrated cleaning liquid to the used aqueous cleaning liquid to improve the cleaning abilities of the aqueous cleaning liquid. The concentrated cleaning liquid is stored in a second concentrated cleaning liquid container 40 and may be pumped into the first liquid tank 37 by a second concentrate cleaning liquid pump 41.

When reusing the aqueous cleaning liquid from the spent first cleaning liquid tank 37, the aqueous cleaning liquid is again filled into the cleaning chamber 1. The vacuum pump 6 reduces the pressure in the cleaning chamber to a level under atmospheric pressure after activating the second liquid inlet valve 33 the liquid is sucked into the cleaning chamber thereby filling the cleaning chamber.

Alternatively, it is possible to empty the aqueous cleaning liquid from the cleaning chamber 1 and into the second liquid tank 38. The outlet 31 is activated by second liquid outlet valve 34 and the aqueous cleaning liquid is pumped out of the cleaning chamber 1 and into the liquid tank by a second cleaning liquid pump 42.

It is possible to add extra concentrated cleaning liquid to the used aqueous cleaning liquid to improve the cleaning abilities of the aqueous cleaning liquid. The concentrated cleaning liquid is stored in a third concentrated cleaning liquid storage container 43 and may be pumped into the second liquid tank 38 by a third cleaning liquid concentrate pump 44.

When reusing the aqueous cleaning liquid from the second liquid tank 38, the liquid is again refilled into the cleaning chamber 1. The vacuum pump 6 reduces the pressure in the cleaning chamber 1 after activating the third liquid inlet valve 35 the liquid is sucked into the cleaning chamber and thereby filling the cleaning chamber 1.

The cleaning chamber 1 may also be emptied by leading spent aqueous cleaning liquid to the sewer. This is done by activating the sewer valve 36 and pump the aqueous cleaning liquid out into the sewer by a sewer pump 45.

When emptying the cleaning chamber 1 there may be provided one or more liquid purifying means 46, 47, 48, e.g. a filter for removing impurities in the spent aqueous cleaning liquid from the cleaning of the damaged electronic device.

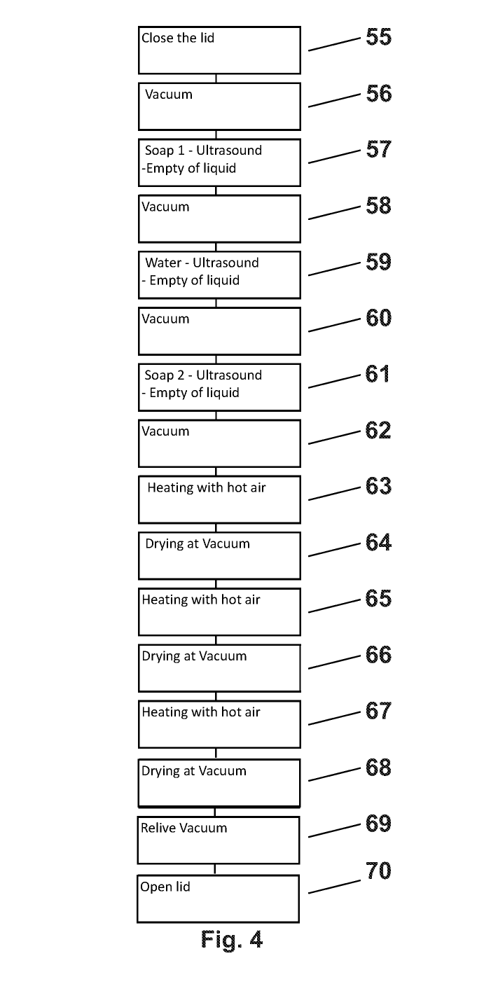

FIG. 4 is a process diagram of a specific method to clean damaged electronic device placed in the cleaning chamber.

First the lid is closed 55 and the vacuum pump 6 applies a reduced pressure to the cleaning chamber 56.

A first cleaning liquid, preferably comprising a soap is added to the cleaning chamber and sonication, preferably by ultrasound, is applied to the cleaning chamber including cleaning liquid and damaged electronic device. After subjecting the cleaning chamber and its content to ultrasound, the cleaning chamber is emptied of cleaning liquid 57 and the cleaning chamber and damaged electronic device is showered in water. Once more the vacuum pumps 6 apply a reduced pressure to the cleaning chamber 58.

Next a rinsing cycle is applied. Water is added to the cleaning chamber and sonic waves, preferably ultrasound, is applied to the cleaning chamber by means of the sonic probes 3 including water and damaged electronic device, after ultrasound the cleaning chamber is emptied of water 59.

Once more the vacuum pump 6 applies a reduced pressure to the cleaning chamber 60, after which a cleaning liquid comprising a second soap is added to the chamber and ultrasound is applied to the cleaning chamber including cleaning liquid and the damaged electronic device. After subjecting to ultrasound the cleaning chamber again is emptied of second cleaning liquid 61 and the cleaning chamber 1 and damaged electronic device is showered in rinsing water.

Next, it is time to dry the restored/damaged electronic device. The pressure in the cleaning chamber is lowered to 0.5-0.7 bar 62 and the cleaning chamber is then heated to approximately at least 40-60° C., or preferably 65-75° C. while keeping the pressure at 0.5-0.7 bar 63. When the cleaning chamber is hot the pressure is reduced to 0.1-0.3 bar while the heating stops 64. The chamber is then left to slowly cool down with the pressure at 0.1-0.3 bar and the liquid inside the restored/damaged electronic device thus evaporates.

This is repeated at least once or twice: The pressure is raised to 0.5-0.7 bar and the cleaning chamber is heated to at least 40-60° C., or preferably 65-75° C. 65 followed by a drop in pressure to 0.1-0.3 bar while cooling down 66. After cooling down the pressure is increased to 0.6 bar and the cleaning chamber is heated to at least 40-60° C., or preferably 65-75° C. 67 followed by a drop in pressure to 0.1-0.3 bar while cooling down 68.

As mentioned above, a preferred method comprises a drying cyclus in which the drying cyclus comprises the steps of

a: heating air 63 entering into the cleaning chamber to a temperature of at least 60° C. at a first reduced pressure of 0.5-0.8 bar,

b: maintaining a chamber temperature of 35-80° C., in particular around 45-55° C. by periodically heating the circulating air during substep b 64, and a second reduced pressure of of 0.5-0.8 bar,

c: reducing the pressure to a third reduced pressure level of 0.01-0.5 bar in substep b.

In step a, a heating boost is applied to the air in the chamber.

In step b, the pressure is maintained or allowed to increase slightly because of evaporation of water, and in step c, the pressure is reduced even further to drive evaporation of any remaining residual water inside the electronic device and thus ensure efficient drying of the electronic device.

The steps b-c in the drying cyclus may be repeated at least one, two, three, four, five, six, seven, eight, nine, ten or more times depending on the amount of water that needs to be removed from the electronic devices during the drying step.

If necessary, in the final repetition of steps b-c, the final substep c may be prolonged in duration in relation to the preceding cycles, to ensure that the internal part of the electronic device is dry and substantially all residual water is drawn out of the electronic device before finalizing the regeneration procedure. In addition the pressure may be reduced even further, e.g. to slightly above absolute vacuum, such as 0.01-0.1 bar in the substep c of the final cyclus.

The duration of steps a-c may be based on a preset time duration to ensure evaporation of the water present in the electronic device after the washing and/or rinsing steps. In steps a and b the chamber temperature is maintained at the desired level to obtain a chamber temperature of 45-55° C. This may be obtained by step a having a duration of 100-720 seconds, or 180-540 seconds or 240-480 seconds. Step b may have a duration of 60-540 seconds, or 90-360 seconds or 120-240 seconds. Step c may have a duration of 100-720 seconds, or 120-540 seconds or 180-480 seconds.

The cleaning and drying of the damaged electronic device is finished and the pressure in the cleaning chamber is relieved 69 and the lid may be opened 70.

The above mentioned temperature and pressures are examples and the drying of the restored/damaged electronic device may be at different temperature and/or pressure.

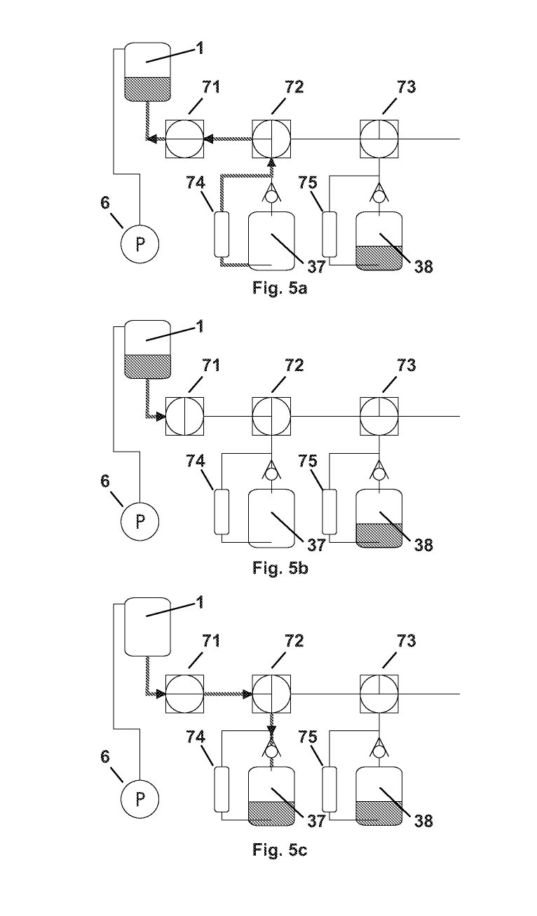

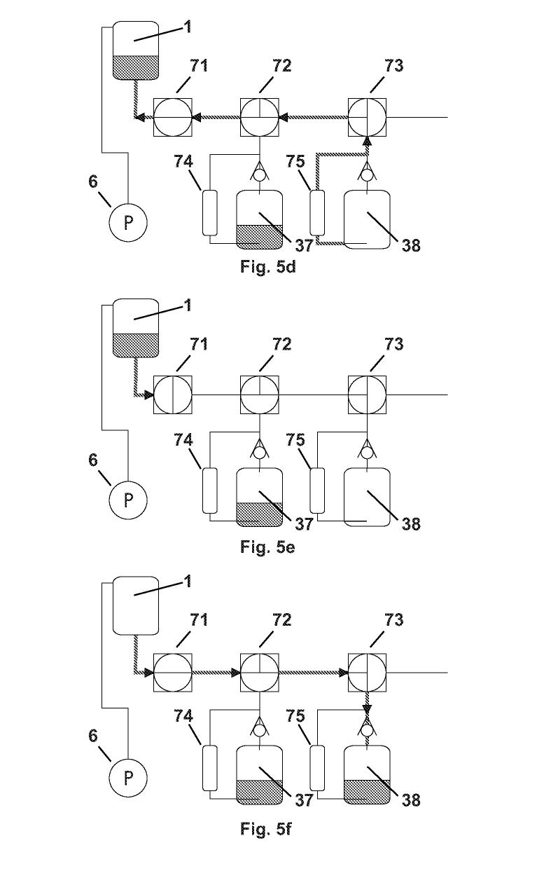

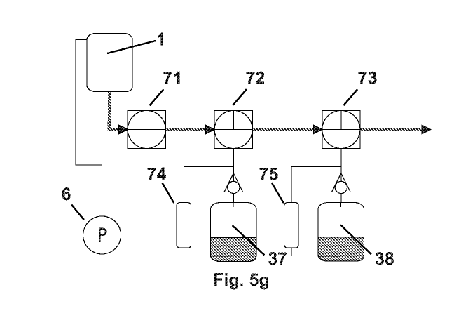

FIG. 5a-5g is an alternative embodiment of the damaged electronic restoration apparatus. There are less pumps and the cleaning chamber 1 is emptied of aqueous cleaning liquid by gravity. The access to and from the cleaning chamber 1 and the liquid tanks 37,38 are controlled by three valves, one two-way valve 71 and two three-way valves 72, 73.

In FIG. 5a the cleaning chamber is filled with aqueous cleaning liquid from the first liquid tank 37. The two-way valve 71 is open to let liquid pass into the cleaning chamber 1, and the first three-way valve 72 is open from the liquid chamber to the first liquid tank. The vacuum pump 6 is reducing the pressure in the cleaning chamber 1, there by sucking the aqueous cleaning liquid from the first liquid tank through a first optional filter 74 into the cleaning chamber.

When the cleaning chamber is sufficiently filled with aqueous cleaning liquid the two-way valve 71 closes as in FIG. 5b and the cleaning chamber 1 is ready to be subjected to sonication.

After sonication the cleaning chamber 1 is emptied back into the first liquid tank 37 by activating the two-way valve 71 as seen in FIG. 5c, the three-way 72 valve still is open between the cleaning chamber 1 and the first liquid tank 37.

Filling and emptying the cleaning chamber to and from the second liquid tank 38 is shown in FIG. 5d-5f. The first three-way valve 72 now has a pass through of liquid from the second liquid tank 38 to the cleaning chamber 1 and is closed off towards the first liquid tank 37.

The second three-way valve 73 is open and passes liquid from the second liquid tank 38 to the cleaning chamber 1. The two-way valve 7 is also open. When the vacuum pump 6 reduces the pressure in the cleaning chamber 1, the aqueous cleaning liquid is simply sucked into the cleaning chamber 1 through the optional filter 75.

When the cleaning chamber is partly or completely filled with the second aqueous cleaning liquid, the two-way valve 71 closes and the cleaning chamber 1 is ready to sonication. After sonication, the cleaning chamber 1 is emptied back into the second liquid tank 38 by activating the two-way valve 71.

When both the three-way valves 72, 73 are open for passage of liquid, and are closed towards the first and second liquid tanks 37,38, the aqueous cleaning liquid is passed to the sewer or similar as seen in FIG. 5g.
1. Chamber
2. Lid
3. Sonic probe
4. Inner plate
5. An outlet for a vacuum pump
6. Vacuum pump
7. Inlet/outlet
8. Valves
9. Connection for aqueous cleaning liquid
10. Connection for aqueous cleaning liquid
11. Connection for dry air
12. Connection for emptying aqueous cleaning liquid
13. Inlet for air
14. Inlet for water
15. Condensation plate
16. Magnetic valve 16a and air cylinder 16b
17. Sprinkler
18. Liquid inlet valve
19. Air valve
20. Pressure relief valve
21. Air cylinder
22. Heating element
23. Air tank
24. Check valve
25. Inlet for water
26. Water inlet valve
27. Inlet for concentrated cleaning liquid
28. First container for concentrated cleaning liquid
29. First cleaning liquid pump
30. First cleaning liquid valve
31. Inlet/outlet
32. A first liquid outlet valve
33. A second liquid inlet valve
34. A second liquid outlet valve
35. Third liquid inlet valve
36. Sewer valve
37. First liquid tank
38. Second liquid tank
39. First liquid outlet pump
40. Second concentrated cleaning liquid container
41. Second concentrated cleaning liquid pump
42. Second cleaning liquid pump
43. Third concentrated cleaning liquid container
44. Third concentrated cleaning liquid pump
45. Sewer pump
46. Filter
47. Filter
48. Filter
49. -
50. -
51. -
52. -
53. -
54. -
55. Close the lid
56. Vacuum
57. Soap, ultrasound, empty
58. Vacuum
59. Water, ultrasound, empty
60. Vacuum
61. Soap, ultrasound, empty
62. Vacuum
63. Heating
64. Drying
65. Heating
66. Drying
67. Heating
68. Drying
69. Relive vacuum
70. Open lid
71. Two-way valve
72. First three-way valve
73. Second three-way valve
74. First filter
75. Second filter

1-14. (canceled)

15. A method comprising regenerating damaged electronic device by a least one cleaning process and a least one drying process, the cleaning process further comprising the steps of:
submerging one or more electronic devices into an aqueous cleaning liquid in a cleaning chamber,
subjecting the aqueous cleaning liquid and the one or more electronic devices to sonication
the dying process comprises the step of:
drying the one or more electronic devices
wherein drying of the one or more electronic devices is done in a drying cycle by periodically heating the cleaning chamber and subjecting the cleaning chamber to reduced pressure and where the cleaning step and the drying step are carried out in the same cleaning chamber, and wherein the drying cycle comprises the steps of:
a: heating air entering into the cleaning chamber to a temperature of at least 60° C. at a first reduced pressure of 0.5-0.9 bar,
b: maintaining a chamber temperature of 35-80° C. and a second reduced pressure level of 0.5-0.9 bar,
c: reducing the pressure to a third pressure level of 0.1-0.5 bar.

16. The method according to claim 15, further comprising repeating steps b-c in the drying cycle at least one, two, three, four, five, six, seven, eight, nine, ten or more times.

17. The method according to claim 15, wherein the frequency and/or the amplitude of the sonic waves is adjusted to the cleaning process and/or varied during at least one cleaning substep.

18. The method according to claim 15, wherein the periodical heating of the cleaning chamber provides a chamber temperature 20-100° C., such 35-80° C. or preferably as 45-70° C.

19. The method according to claim 15, wherein the aqueous cleaning liquid comprises water, such as tap water or demineralised water and optionally the aqueous cleaning liquid further comprises one or more detergents, such as one or more alkaline detergents or acid detergents, or detergents having amphoteric properties and/or mixtures thereof.

20. Apparatus comprising a damaged electronic restoration apparatus by means of a cleaning process according to claim 15, wherein the apparatus comprises:
a pressure tight and/or airtight cleaning chamber,
at least one liquid inlet arranged for at least partly fill the cleaning chamber with an aqueous cleaning liquid thereby submerging the damaged electronic in the aqueous cleaning liquid
at least one liquid outlet arranged for emptying the cleaning chamber for aqueous cleaning liquid
one or more sonic probes for subjecting the aqueous cleaning liquid and the electronic device to sonication, and
at least one pumping means for subjecting the cleaning chamber to a reduced pressure and
wherein the cleaning chamber additionally comprises:
one or more air entering means for entering air into the chamber
one or more temperature regulating means
whereby the cleaning chamber is also configured as a drying chamber, to dry the regenerated electronic devices in a drying cycle having one or more drying steps under reduced pressure, which apparatus is configured so as to perform the drying cycle that comprises the steps of:
a: the temperature controlling means heating air entering into the cleaning chamber to a temperature of at least 60° C. and the pumping means controlling the pressure so as to maintain at a first reduced pressure of 0.5-0.9 bar,
b: maintaining a chamber temperature of 35-80° C. and the pumping means controlling the pressure to a second reduced pressure level of 0.5-0.9 bar, and
c: the pumping means controlling the reducing the pressure to a third pressure level of 0.1-0.5 bar.

21. The apparatus as according to claim 20, wherein filling the cleaning chamber with liquid is done by the at least one pumping means applies a reduced pressure to the cleaning chamber and thereby sucking the aqueous cleaning liquid into the cleaning chamber through the at least one liquid inlet means.

22. The apparatus according claim 20, wherein the liquid inlet means is also functioning as liquid outlet means.

23. The apparatus as according claim 20, wherein the apparatus comprises at least one liquid tank for storing at least a part of the used aqueous cleaning liquid, and means for reuse of aqueous cleaning liquid or liquids in the one or more cleaning steps.

24. The apparatus according claim 20, wherein the cleaning chamber further comprises at least one condensation plate.
